(19) United States
(12) Patent Application Publication
(10) Pub. No.: US 2012/0148803 A1
(43) Pub. Date: Jun. 14, 2012

(54) FIBER-REINFORCED POLYURETHANE MOLDED PART COMPRISING THREE-DIMENSIONAL RAISED STRUCTURES

(75) Inventors: Stephan Schleiermacher, Pulheim (DE); Roger Scholz, Doenrade (NL); Hans-Guido Wirtz, Leverkusen (DE); Klaus Franken, Bergisch-Gladbach (DE)

(73) Assignee: Bayer MaterialScience AG, Leverkusen (DE)

(21) Appl. No.: 13/391,961

(22) PCT Filed: Aug. 17, 2010
(86) PCT No.: PCT/EP2010/005047

§ 371 Date: Feb. 23, 2012

(30) Foreign Application Priority Data
Aug. 26, 2009 (DE) 10 2009 038 867.2

(51) Int. Cl. B32B 3/30; B29C 70/42; B29C 70/06

(52) U.S. Cl. 428/172; 428/156; 264/330; 264/309

(57) ABSTRACT

The invention relates to a fibre-reinforced polyurethane moulded part which has structures such as ribs, struts or domes, said structures being likewise fibre-reinforced.

The present invention relates to a fiber-reinforced polyurethane molded part which has structures such as ribs, struts or domes, said structures being likewise fiber-reinforced.

The fiber reinforcement of different polymers is widespread. The combination of a fiber and a polymeric matrix results in a material having the low density of the polymer while possessing a high specific rigidity and strength. This is why such composite materials are interesting for lightweight construction applications, in particular. They are used for preparing mainly two-dimensional structures in which the fibers can distribute uniformly.

The use of fibers in polymeric structures is known, for example, from U.S. Pat. No. 3,824,201. Mats, nonwovens, long fibers or continuous fibers are wetted by polyester-polyurethane compounds described therein, followed by cutting before they cure.

In addition to the use of natural fibers, the use of glass fibers has become established for reinforcing polymeric molded parts. For mechanical applications, the glass fibers are mostly in the form of rovings, nonwoven or woven fabrics. Glass fibers have a high strength and rigidity.

The high strength of the glass fibers is due to the influence of size. The elongation at break of an individual fiber can be up to 5%. The tensile strength and compression strength of the glass fiber provides for a particular rigidity of the plastic material while some flexibility is maintained.

The modulus of elasticity of glass fibers is little different from that of a solid material volume of glass. Glass fibers have an amorphous structure whose molecular orientation is random. Glass fibers have isotropic mechanical properties. Glass fibers exhibit an ideal linear elasticity until they break. They have only a very small material damping characteristic. The rigidity of a component part made of a glass fiber reinforced plastic material is determined by the modulus of elasticity, by the direction and volume fraction of the glass fibers, and to a low extent by the properties of the matrix material, because a significantly softer plastic material is used in most cases.

Today, glass fiber reinforced plastic materials have great importance, for example, in aerospace engineering or in automotive construction including automobiles, transport machines, construction machines, mobile homes, agricultural machines, trucks, semi-trailers, but also housing parts for stationary machines or non self-propelled machines as well as truckboxes. In aerospace engineering, composite materials with long fibers are predominantly employed for building load-bearing parts. In the automobile industry, long fibers of glass or natural fibers are currently used also for reinforcing thermoplastic components (e.g., trim parts).

If long glass fibers are mixed into a polymeric mixture, they will not arrange themselves in regular patterns; rather, they are randomly distributed. Long glass fibers in a random arrangement in polymeric structures are known, for example, from U.S. Pat. No. 4,791,019. However, methods by which the glass fibers are oriented in a defined direction are also known. This is described, for example, in CN 101 314 931 A.

Further, methods are known in which a two-dimensional element is coated with a fiber-reinforced polyurethane layer. This coating increases the stability of the actual product. Such a method is described, for example, in WO 2007/075535 A2 and DE 10 2006 046 130 A1.

Fiber-reinforced molded parts are known from DE 196 149 56 A1 and DE 10 2006 022 846 A1. In addition to glass fibers, mats are also employed for reinforcing the polymeric structure. Such mats, woven fabrics or knitwear can also consist of glass fibers.

When a fiber-reinforced polyurethane molded part is prepared by a RIM (reaction injection molding) process, a mixture of polyurethane and the fibers is usually distributed two-dimensionally in the lower part of an opened mold by a robot. By closing the mold with the upper part or punch, the mixture is pressed into the desired shape. The pressure also causes bubbles trapped in the mixture to escape. The shape of the product obtained is determined by the shape of the mold. Structures derived from the glass fibers can be seen on the surface of the final product even after the compression. In order to achieve a more uniform surface, it is possible to use glass fibers of different lengths. Thus, JP 59086636 A describes a glass fiber reinforced resin composition in which the glass fibers have different lengths. WO 00/40650 also uses long and short fibers to reinforce polyurethane compounds. The short fibers have lengths of 0.635 cm (¼ inch) or less; the long fibers have lengths of 0.635 cm (¼ inch) or more. The PUR and the long and short fibers are mixed in a fixed mass ratio. Therefore, the total fiber proportion in a rib is always lower than in the area if the long fibers do not penetrate into the rib.

DE 101 20 912 A1 describes a composite component made of polyurethane and its use in exterior automobile body parts. The corresponding composite components are constituted by two layers, one layer containing full-area short fiber reinforced polyurethane having a paintable surface finish. The second layer contains long fiber reinforced polyurethane. The use of short fibers results in a smooth, i.e., paintable, surface. However, this layer has other properties, especially mechanical properties, than those of the long fiber reinforced layer.

From DE 10 2005 034 916 A1, a process for preparing a foamed part is known. Such a foamed part consists of fiber-reinforced polyurethanes, for example. Support materials are temporarily inserted into the structure. However, they will not bond to the plastic material, so that the corresponding support material can be peeled off after curing. The foamed part obtained then exhibits a structure on its surface.

The preparation of such fiber-reinforced polyurethanes is frequently performed by a spray process. One such process is described, for example, in DE 10 2005 048 874 A1.

The preparation of such materials is normally effected by directing the long fibers used for reinforcement laterally into the spray jet of a polyurethane reactive mixture through a funnel-shaped application unit firmly attached with the polyurethane (PUR) spray-mixing head, preferably supported by compressed air. Devices in which the polyurethane mixture is produced around a central tube are also commercially available. Within the tube, long fibers are transported by a current of air. At the end of the tube, the “liquid hose” of freshly mixed polyurethane components will wet the fiber/air stream. In the case of materials that are reinforced by long fibers, so-called rovings are mostly used as the starting material; these are bundles of continuous non-twisted drawn fibers that first pass a cutter, which is also attached to the PUR spray-mixing head, before the cut fibers are wetted with the polyurethane.

In such spray processes, a distribution of the fiber-PUR reaction mixture as uniform as possible, mostly across several layers, is sought. Therefore, in applications with a high demand of reproducibility, the spray-mixing heads including the chute are guided by robots.

A major advantage is the fact that the long fibers are wetted with polyurethane reactive mixture essentially from all sides. Such PUR-wetted fibers have no unitary structure. Rather, there are air inclusions between the irregularly arranged long fibers. Accordingly, the PUR-wetted long fibers are inserted into an open mold for preparing a molded part. The loosely stacked fibers are forced into the final position by closing the mold under pressure, optionally at elevated temperature. Air inclusions are also pressed out in this process. Using such a process, it is possible to prepare different components, for example, dashboard supports, door interior trim parts, backrest trim parts, hat shelves, horizontal and vertical exterior trim parts, such as hoods, roof modules, lateral trim parts.

For reinforcement, the corresponding components often contain ribs, struts, domes or similar three-dimensional raised structures. These are required, for example, for later attachment, for boltings and inserts. Such structures are obtained from grooves and/or conical recesses in the upper mold, the punch. Frequently, the gap width or diameter/cross-section of these recesses is so small that long fibers cannot penetrate into the cavities with the foaming PUR. Only those long fibers whose orientation matches that of the cavities can get into the cavities along with the foam. However, the majority of the long fibers tilt, so that mainly PUR, but no or only very few fibers penetrate. Thus, it cannot be ensured that later formed ribs, struts and/or domes are fiber-reinforced.

It follows that such structures having no or a smaller proportion of fibers have other properties than those of the bulk of the molded part. Thus, the coefficient of longitudinal thermal expansion is larger if less fibers are present. These differences in the coefficient of longitudinal thermal expansion will lead to a bending of the actual molded part when subjected to a thermal load.

In addition, the projecting structures have a lower modulus of elasticity in bending. Accordingly, the domes, ribs and/or struts are not sufficiently reinforced. Thus, using them as force transmission points, smaller loads can be held than would be possible for a completely fiber-reinforced polyurethane molded part. Any inserted screws will not grip as well either.

In the following, a simple model is described for estimating the probability with which a fiber (for example, glass fiber) applied to a mold part in a spray process can penetrate into a slender component structure, such as a rib.

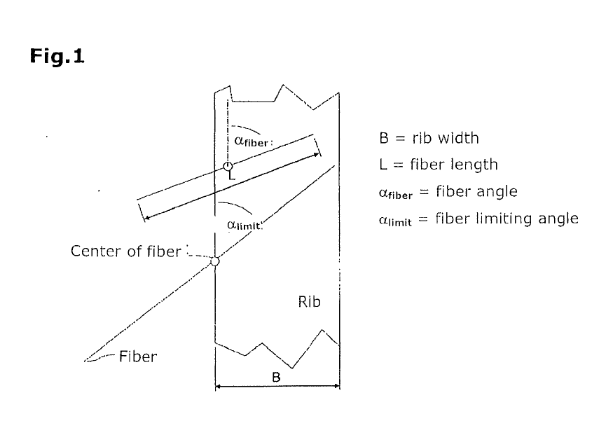

Thus, the following assumptions are made:
The individual fiber is considered slender and rigid (fiber length>>fiber thickness);
The fibers will be deposited first in the mold plane before they are transported together with the rising matrix material into regions (for example, ribs) oriented vertically to the mold plane (two-dimensional view);
The fiber orientation and fiber length will be used exclusively as criteria of whether a fiber can penetrate into a rib. Thus, the probability of penetration by those fibers that are present immediately “below” a corresponding component structure, such as a rib, is estimated. A mutual interference between the fibers is excluded for the sake of simplicity.
A fiber can penetrate into a rib if and only if the fiber length projected into the rib width is smaller than twice the rib width (see FIG. 1);
For the distribution of the fiber orientations (fiber angles), it is considered that all orientations are equally probable, i.e., there is no preferential direction of fiber orientation.

The probability of an event (here: the application of a fiber in a particular range of angles 0<α_{fiber}<αₗᵢₘᵢₜ is defined as:

$$P = \frac{g}{m}$$

with
P=probability (a value between 0 and 1)
g=number of favorable cases
m=number of possible cases

The number of possible cases, m, corresponds to the number of all fibers applied, n. Favorable cases are all those fiber orientations that are between 0° and αₗᵢₘᵢₜ, i.e.:

$$g = \frac{{α}_{limit}}{360 °} \cdot n$$

Thus, we obtain as the probability of the occurrence of a fiber orientation within the above mentioned range of angles:

$$P = \frac{{α}_{limit}}{360 °}$$

However, in a complete 360° rotation of a fiber, a favorable range of angles for penetrating into the rib occurs not only once, but four times. These are the ranges of angles (0<α_{fiber}<αₗᵢₘᵢₜ), (180°−αₗᵢₘᵢₜ<α_{fiber}<180°), (180°<α_{fiber}<180°+αₗᵢₘᵢₜ), and (360°−αₗᵢₘᵢₜ<α_{fiber}<360°). Thus, it results as the probability of the penetration by a fiber into a rib (P_{R}):

$${P}_{R} = \frac{{α}_{limit}}{360 °} \cdot 4 = \frac{arcsin ( \frac{2 \cdot B}{L} )}{360 °} \cdot 4$$

$$for \frac{2 \cdot B}{L} \leq 1$$

For ratios of rib width to fiber length of more than 0.5, P_{R} becomes 1 by definition (see assumptions) because the fiber orientation is no longer important then.

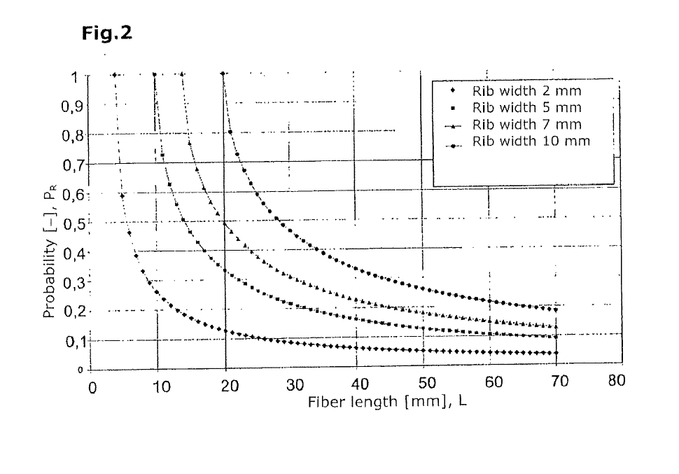

FIG. 2 shows the probability of penetration by a fiber into a rib (P_{R}) as a function of the fiber length for four different rib widths.

FIG. 1 illustrates the relationship between the fiber orientation, length and rib width. It is assumed that a fiber whose length is at most double the rib width can always penetrate into the rib (independently of the fiber angle). The idea is that the fiber touches only one edge of the rib and that the last position where it can be dragged along into the rib (“tilted in”) is when the point of contact between the fiber and the rib edge is the center of the fiber. Longer fibers can penetrate into the rib only if their angle αfiber is smaller than a limiting angle αₗᵢₘᵢₜ, since the fiber would otherwise rest on both edges of the rib. If the fiber rests on only one edge of the rib and the center of the fiber is outside the rib, it is considered that such a fiber cannot penetrate into the rib. The assumptions made herein will lead to a higher probability of penetration by the fiber into the rib, since the fibers will certainly interfere mutually and become less mobile in reality.

Thus, the object of the present invention is to provide a fiber-reinforced polyurethane molded part which has raised three-dimensional structures, wherein the bulk of the molded part as well as these structures are reinforced with fibers.

In a first embodiment, the object is achieved by a long fiber reinforced polyurethane molded part which has three-dimensional raised structures, especially ribs, struts and/or domes, characterized by further containing short fibers in addition to said long fibers, wherein the weight ratio of short fibers and/or plate-like fillers to the fiber-free polyurethane matrix in a volume of ribs, struts and/or domes is higher than the weight ratio of short fibers and/or plate-like fillers to the fiber-free polyurethane matrix in two-dimensional areas outside the raised structures.

Natural or synthetic fibers can be used as said long fibers. In addition to glass fibers and basalt fibers, carbon fibers, aramid fibers, natural fibers, for example, hemp fibers (sisal, flax), are also applied. Glass fibers are preferably used.

These long fibers are preferably derived from a roving and are cut in an accordingly provided cutter, so that the fibers in the molded part have a length of, for example, from 1 to 30 cm, preferably from 2.5 to 10 cm.

According to the invention, said three-dimensional raised structures, i.e., ribs, struts and/or domes, contain short fiber reinforced polyurethane. According to the invention, the term “short fibers” also includes plate-like fillers, for example, sheet silicates, especially micas. Natural or synthetic fibers are employed as said short fibers. The short fibers may be, for example, milled glass fibers, basalt fibers or carbon fibers. However, wollastonite obtainable, for example, under the trade mark Tremin®, or a similar mineral may also be used. The fibrous acicular crystals of Tremin® are preferred according to the invention.

The size of the short fibers/plate-like fillers is defined by their length/diameter. In particular, the length of short fibers/diameter of plate-like fillers is from 1 μm to 800 μm, preferably from 4 μm to 600 μm, more preferably from 100 μm to 500 μm.

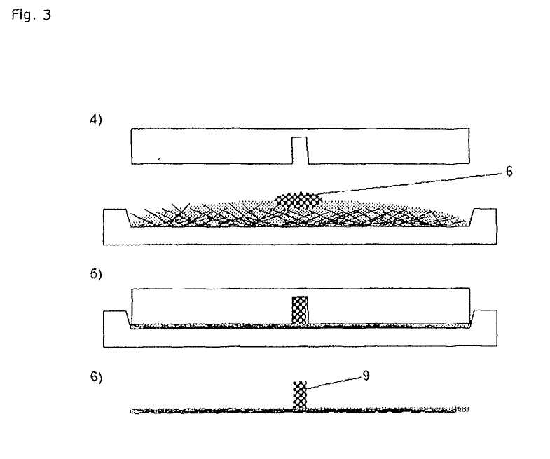

According to the invention, the mixture of polyurethane reactive mixture and long fibers is introduced into an opened mold as shown in FIG. 3. Subsequently, polyurethane is applied together with short fibers locally at the corresponding sites of the raised structures. The polyurethane reactive mixture containing short fibers is applied to those places, in particular, where the cavities for the ribs, struts and/or domes in the punch are, and will flow freely into these cavities after the mold has been closed.

If the cavities for ribs, struts and/or domes are in the lower part of the mold, the polyurethane reactive mixture containing the short fibers can be applied first into the cavities, followed by two-dimensionally applying the polyurethane reactive mixture containing the long fibers.

Thus, the short fibers have a length that is short enough for them to flow freely into the cavities for the ribs, struts and/or domes. Thus, they flow into the cavities along with the PUR, which is optionally foaming, while long fibers will tilt and cannot penetrate into the cavities along with the PUR, or hardly so.

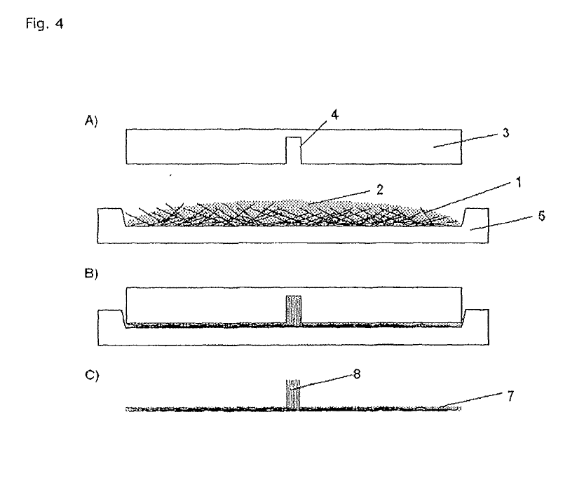

In FIG. 4, a corresponding process is described without the use of short fibers or plate-like fillers, in which the raised regions remain unfilled.

Preferably, a polyurethane molded part according to the invention has an additional outer skin joined on the side where there are no three-dimensional structures. In particular, such an exterior skin consists of a deep-drawn sheet, especially one consisting of acrylonitrile-butadiene-styrene (ABS), poly(methyl methacrylate) (PMMA), acrylonitrile-styrene-acrylic ester (ASA), polycarbonate (PC), thermoplastic polyurethane, polypropylene (PP), polyethylene (PE), and/or polyvinyl chloride (PVC).

Alternatively to the above mentioned exterior skins, the molds may also include so-called in-mold coatings or gel coats. In-mold coating is a process by which the painting of a plastic molded part is performed already within the mold. Thus, a highly reactive two-component paint is placed into the mold by a suitable painting technique. Thereafter, the long fiber reinforced polyurethane layer is applied into the open mold according to the invention. Subsequently, the short fiber reinforced polyurethane component is applied locally as above, and the mold is closed.

In another embodiment, the object of the present invention is achieved by a process for preparing a fiber reinforced polyurethane molded part. Such a process comprises the wetting of long glass fibers with a polyurethane reactive mixture, the introducing of this mixture into the opened mold, the local applying of short fiber reinforced PUR, and the closing of the mold.

In particular, a process is preferred in which the solids-containing gas stream or streams are not metered into the already dispersed spray jet of the reaction mixture, but are incorporated into the jet that is still liquid but not yet dispersed, within the mixing chamber of the mixing head.

According to the invention, a “liquid jet of a PUR reaction mixture” means a fluid jet of a PUR material, especially in the region of a mixing chamber for mixing the reaction components in a liquid form, that is not yet in the form of fine droplets of reaction mixture dispersed in a gas stream, i.e., in particular, in a liquid viscous phase.

The processes of the prior art essentially use a gas stream or a corresponding nozzle for atomizing a PUR reaction mixture, and meter a solids-containing gas stream into such an atomized PUR spray jet. For any spray jet, and also in this case, it holds that the distance between neighboring spray particles orthogonal to the main spraying direction of a spray jet increases as the distance from the spray nozzle increases. The probability that solid particles collide with polyurethane droplets or already wetted filler particles and are wetted thereby is inevitably quickly decreasing. The situation changes if the mixing of fillers and polyurethane is effected in a mixing chamber according to the process of the invention.

The device is characterized in that solids are directed by a conveying gas flow into a mixing chamber, where they hit a liquid jet of a PUR reaction mixture. The gas flows with solids are allowed to collide in the mixing chamber by letting them enter the mixing chamber through two or more points. Neighboring spray jets can form large angles with one another and be perpendicular to a circular circumferential line of the cylindrical mixing chamber. They thus collide in the imaginary center axis of the mixing chamber. However, they may also be injected tangentially and form a vortex that defines a circle that is orthogonal to the main direction of flow in the mixing chamber. In the process according to the invention, the particles cannot escape each other or move away from each other because the walls of the mixing chamber prevent this. Therefore, solids are forcibly wetted with the PUR reaction mixture with no losses in the interior of the mixing chamber in the process according to the invention and thus become part of a homogeneous gas/solid/PUR material mixture.

Preferably, the mixing quality of the resulting gas/solid/PUR material mixture in the mixing chamber is again enhanced by additional air vortices. The air vortices are produced by air from tangential air nozzles. The circular areas surrounded by them form a right angle with the axis of the main direction of flow in the mixing chamber.

According to the invention, one and the same PUR may be used to employ the short fibers or increase their proportion; usual methods place the short fibers into the polyol formulation, so that the concentration is unchanged throughout the production process.

The upper part of the mold has cavities into which the foaming PUR reactive mixture can then penetrate. In particular, the short fiber reinforced reactive mixture will penetrate here.

A polyurethane molded part prepared by such a process according to the invention not only has a high stability in the actual body. Since the short fiber reinforced polyurethane component foams and fills the cavities of the upper mold, the later domes, ribs and/or struts are also fiber-reinforced. A higher stability of these structures is achieved thereby.

### LIST OF REFERENCE SYMBOLS

1 freshly mixed polyurethane

2 long fibers

3 upper mold half

4 recess for rib

5 lower mold half

6 freshly mixed polyurethane with short fibers

7 component with two-dimensionally pressed long glass fibers

8 rib of a component filled with non-reinforced polyurethane

9 rib of a component filled with short fiber reinforced polyurethane

1. A long fiber reinforced polyurethane molded part which has three-dimensional raised structures, especially ribs, struts and/or domes, characterized by further containing short fibers in addition to said long fibers, wherein the weight ratio of short fibers and/or plate-like fillers to the fiber-free polyurethane matrix in a volume of ribs, struts and/or domes is higher than the weight ratio of short fibers and/or plate-like fillers to the fiber-free polyurethane matrix in two-dimensional areas outside the raised structures.

2. The polyurethane molded part according to claim 1, characterized in that said long fibers comprise glass fibers.

3. The polyurethane molded part according to claim 1, characterized in that said long fibers have a length of from 1 to 30 cm, especially from 2.5 to 10 cm.

4. The polyurethane molded part according to claim 1, characterized in that short fibers have a length/diameter of from 1 to 800 μm, especially from 4 to 600 μm.

5. The polyurethane molded part according to claim 4, characterized in that said short fibers comprise milled glass fibers.

6. The polyurethane molded part according to claim 5, characterized in that said short fibers comprise wollastonite fibers.

7. The polyurethane molded part according to claim 1, characterized in that the side reinforced with long fibers further comprises an exterior skin.

8. The polyurethane molded part according to claim 7, characterized in that said exterior skin consists of a deep-drawn sheet, especially one consisting of acrylonitrile-butadiene-styrene (ABS), poly(methyl methacrylate) (PMMA), acrylonitrile-styrene-acrylic ester (ASA), polycarbonate (PC), thermoplastic polyurethane, polypropylene (PP), polyethylene (PE), and/or polyvinyl chloride (PVC).

9. The polyurethane molded part according to claim 7, characterized in that said exterior skin comprises a two-layer sheet.

10. The polyurethane molded part according to claim 7, characterized in that said exterior skin comprises a metal foil, especially an aluminum foil or a steel foil.

11. The polyurethane molded part according to claim 7, characterized in that said exterior skin comprises an in-mold coating or a gel coat.

12. A process for preparing a polyurethane molded part according to claim 1, characterized in that
(a) long fibers are wetted with a PUR reactive mixture, then introduced into an opened mold;
(b) short fiber reinforced PUR reactive mixture is locally applied; and
(c) the mold is subsequently closed with the upper mold.

13. The process according to claim 12, characterized in that steps (a) and (b) are swapped.

14. The process according to claim 12, wherein
i) a gas stream containing short fibers is introduced into a liquid jet of a polyurethane reactive mixture, wherein the polyurethane jet containing said short fibers is sprayed;
ii) a gas stream containing long fibers is optionally introduced into this spray jet;
iii) said PUR spray jet containing the short fibers and optionally the long fibers is sprayed into an open mold or onto a substrate support;
iv) the amount of short fibers under (i) is optionally increased if no gas stream containing the long fibers is simultaneously introduced.

15. The process according to claim 12, characterized in that an upper part or a lower part of the mold having cavities for ribs, struts and/or domes is employed.

16. The process according to claim 12, characterized in that first an exterior skin is placed into the opened mold, then the PUR-wetted long fibers are introduced, whereupon short fiber reinforced PUR reactive mixture is additionally applied locally, followed by closing the mold with the upper part.
